(19) United States
(12) Patent Application Publication
(10) Pub. No.: US 2010/0324818 A1
(43) Pub. Date: Dec. 23, 2010

(54) PRESENTATION OF NAVIGATION INSTRUCTIONS USING VARIABLE CONTENT, CONTEXT AND/OR FORMATTING

(75) Inventors: Andrew W. Gellatly, Macomb, MI (US); Bhavna Mathur, Novi, MI (US); Matthew M. Highstrom, South Lyon, MI (US); Cody R. Hansen, Shelby Township, MI (US); John P. Weiss, Shelby Township, MI (US)

Correspondence Address: INGRASSIA FISHER & LORENZ, P.C. (GM), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/487,872

(22) Filed: Jun. 19, 2009

(51) Int. Cl. G01C 21/34

(52) U.S. Cl. 701/211

(57) ABSTRACT

A navigation system is provided for instructing an operator of a vehicle. The navigation system includes a navigation processor configured to obtain a destination location, and to generate a proposed route to the destination location. The navigation system also includes a presentation element coupled to the navigation processor, the presentation element configured to provide navigation instructions to the operator. The navigation system also has a selection module coupled to or incorporated into the navigation processor. The selection module is configured to select a designated navigation instruction scheme from a plurality of different navigation instruction schemes. For a given navigation instruction, the plurality of different navigation instruction schemes provide different instruction content. During operation, the presentation element provides navigation instructions for the proposed route, using the designated navigation instruction scheme.

### TECHNICAL FIELD

Embodiments of the subject matter described herein relate generally to vehicle navigation and route planning systems. More particularly, embodiments of the subject matter relate to a vehicle navigation system that uses different schemes for presenting navigation instructions.

### BACKGROUND

The prior art is replete with different types of electronic navigation systems. Some electronic navigation systems are handheld, and others are vehicle-based. A vehicle navigation system generally provides navigation instructions, location data, and map information to the vehicle operator. Some existing vehicle navigation systems attempt to optimize a route based upon different factors. Route calculation is typically performed by examining a number of possible paths, and selecting the “best” path according to a number of optimization rules. For instance, the shortest possible route may be chosen to minimize the distance traveled or high-speed roads may be chosen to minimize travel time. Some advanced navigation systems utilize real-time traffic congestion data in an attempt to guide the vehicle away from traffic jams. After the optimization criteria have been selected, automated vehicle route guidance is typically performed in a two-step process: (1) a proposed route is calculated from a starting position of the vehicle to the desired destination; and (2) guidance instructions are presented to the vehicle operator as the vehicle traverses the proposed route.

Some existing vehicle navigation systems allow the user to select a voice, language, or accent to be used for providing navigation instructions. For example, the user might be able to choose whether the navigation instructions are presented in English, Spanish, French, Japanese, or the like. As another example, the user might be able to select whether the navigation instructions are announced by a female voice, a male voice, a voice having a British accent, a voice having a German accent, etc. However, these vehicle navigation systems typically provide navigation instructions using words or content that convey a certain predefined style, format, or tone. In other words, the actual content of the announced message does not change, even though the voice or language may vary. As a result, the operator might disable or mute the system, or might subconsciously ignore or disregard navigation instructions that are deemed to be too assertive, too chatty, annoying, or are otherwise ineffective for the operator.

### BRIEF SUMMARY

A navigation method is provided for instructing an operator of a vehicle with a navigation system. The method selects a designated navigation instruction scheme from a plurality of different navigation instruction schemes, where each of the different navigation schemes causes the navigation system to present a given navigation instruction using distinctive content, context, or formatting. The method also obtains a destination location, generates a proposed route to the destination location, and provides navigation instructions for the proposed route, using the designated navigation instruction scheme.

A navigation system for instructing an operator of a vehicle is also provided. The navigation system includes a navigation processor, a presentation element, and a selection module. The navigation processor is configured to obtain a destination location, and to generate a proposed route to the destination location. The presentation element provides navigation instructions to the operator, and the selection module selects a designated navigation instruction scheme from a plurality of different navigation instruction schemes. For a given navigation instruction, the plurality of different navigation instruction schemes provide different instruction content. The presentation element provides navigation instructions for the proposed route, using the designated navigation instruction scheme.

Also provided is another navigation method for instructing an operator of a vehicle with a navigation system. This method uses the navigation system to present a questionnaire to the operator. The questionnaire prompts the operator to respond to a number of questions. The method continues by obtaining, with the navigation system, the operator's answers to the questions. Next, the method automatically selects, in response to the operator's answers, a default navigation instruction scheme from a plurality of different navigation instruction schemes. Then, the method provides navigation instructions in accordance with the automatically selected navigation instruction scheme.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a schematic representation of an embodiment of a vehicle navigation system;

FIG. 2 is a flow chart that illustrates an embodiment of a variable guidance navigation process; and

FIG. 3 is a flow chart that illustrates an embodiment of a navigation system self-configuration process.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

Techniques and technologies may be described herein in terms of functional and/or logical block components, and with reference to symbolic representations of operations, processing tasks, and functions that may be performed by various computing components or devices. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

For the sake of brevity, conventional techniques related to signal processing, image processing, data transmission, general vehicle navigation system operation, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the subject matter.

Field research has shown that many users of vehicle navigation systems disable auditory route guidance instructions because the navigation system does not provide instructions in a format or methodology that is helpful to them. For example, a navigation system may be too “chatty” for some users, which can be annoying. After turning off audible route guidance prompts, users then rely on glances to the navigation system display to determine when an upcoming driving maneuver is needed. Moreover, drivers tend to take quick glances at the display element to monitor whether the state of the display has changed in anticipation of a driving maneuver.

The systems and methodologies described herein enhance conventional vehicle navigation techniques in several ways. For example, a navigation system can be designed to support user customization of the style and format of navigation instructions. The customization could be based upon user selections and/or in response to questions presented to the user by the navigation system itself during a “learning” procedure. Such customized navigation instruction schemes are likely to be left enabled by the user, and a personalized scheme provides navigation instructions in a manner that will be understood and utilized well by the driver. In addition, since the information presented will be in accordance with the needs and preferences of the operator, the operator workload should be reduced, resulting in fewer missed maneuvers. Customization will also enhance the ownership experience, allowing the user to differentiate their navigation system from others.

Navigation instructions could be presented using one or more of the following formats, styles, and content, without limitation: distance to the next maneuver read aloud in feet, yards, meters, blocks, streets, etc.; distance callouts read more/less frequently when approaching a maneuver; landmark names presented; cardinal directions presented; more/less verbose, polite, assertive, aggressive, formal, and/or authoritative navigation instructions; navigation instructions presented a long/short distance away from the approaching driving maneuver; “tour guide” information is provided with the navigation instructions. Moreover, the navigation system could support a learning, training, or setup wizard feature where the operator is presented with a survey or questionnaire that is used to automatically recommend one or more settings that influence the manner in which the navigation instructions are presented during use.

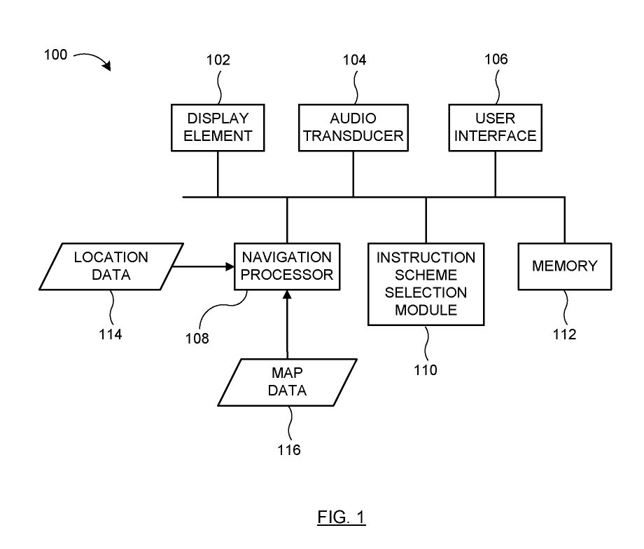

Turning now to the figures, FIG. 1 is a schematic representation of an embodiment of a navigation system 100, which is suitably configured to instruct an operator of a vehicle. For this example, the system 100 is deployed onboard a host vehicle, such as an automobile. In practice, the system 100 may be implemented as part of an onboard vehicle navigation system, an onboard vehicle entertainment system, an onboard display system, an onboard vehicle instrumentation cluster, or the like. The illustrated embodiment of the system 100 includes, without limitation: a display element 102; at least one audio transducer 104 (e.g., a speaker); a user interface 106; a navigation processor 108; an instruction scheme selection module 110; and a suitable amount of memory 112. In practice, the various components of the system 100 are coupled together in a manner that facilitates the communication of data, instructions, control signals, and possibly other signals. In practice, the system 100 may include additional components configured to perform conventional functions that are unrelated to the subject matter described here.

Generally, the navigation processor 108 is configured to perform or otherwise support the various operations and functions described herein. The navigation processor 108 may include one processor device or a plurality of cooperating processor devices. Moreover, the navigation processor 108 may be implemented or performed with a general purpose processor, a content addressable memory, a digital signal processor, an application specific integrated circuit, a field programmable gate array, any suitable programmable logic device, discrete gate or transistor logic, discrete hardware components, or any combination designed to perform the functions described here. A processor device may be realized as a microprocessor, a controller, a microcontroller, or a state machine. Moreover, a processor device may be implemented as a combination of computing devices, e.g., a combination of a digital signal processor and a microprocessor, a plurality of microprocessors, one or more microprocessors in conjunction with a digital signal processor core, or any other such configuration.

The memory 112 accommodates the saving and storing of data, software program code, and other information used to support the operation of the system 100. The memory 112 may be realized as RAM memory, flash memory, EPROM memory, EEPROM memory, registers, a hard disk, a removable disk, a CD-ROM, or any other form of storage medium known in the art. The memory 112 can be coupled to other elements of the system 100 to support the reading of information from, and the writing of information to, the memory 112. In certain embodiments, the memory 112 is integral to the navigation processor 108. For example, the navigation processor 108 and the memory 112 may reside in an ASIC or be implemented with a system on a chip.

For this embodiment of the system 100, the navigation processor 108 obtains location data 114 from an appropriate source that provides data indicative of the current vehicle location or position. In one practical embodiment, the location data source is realized as an onboard GPS receiver/processor that derives the current geographic position of the vehicle from GPS data received by the vehicle in real-time or substantially real-time.

The navigation processor 108 is also configured to obtain map data 116 from an appropriate source that provides data indicative of current cartographic, topological, location, road, and possibly other data useful to the system 100. The map data 116 can represent locally stored, cached, downloaded, or accessible information, which can be processed by the navigation processor 108. For example, in a fully onboard implementation, the map data source(s) may be realized as one or more hard disks, semiconductor memory devices, portable storage media, or the like. In an alternate embodiment, the map data source(s) may be realized as an onboard memory cache that temporarily stores the map data 116 that is downloaded from remote databases.

The display element 102, the audio transducer 104, and the user interface 106 may be configured in accordance with conventional vehicle navigation, information, or instrumentation systems to enable onboard interaction with the vehicle operator. The display element 102 may be a suitably configured LCD, plasma, CRT, or head-up display, which may or may not be utilized for other vehicle functions. In accordance with known techniques, an appropriate display driver of the system 100 can provide rendering control signals to the display element 102 to cause the display element 102 to render and present maps, proposed routes, roads, navigation direction arrows, and other graphical representations, elements, or indicia as necessary to support the function of the system 100. As used here, the display element 102 represents one suitable embodiment of a presentation element or device for the navigation system 100, which can be used to display graphical representations of navigation instructions to the operator.

The audio transducer 104 may be devoted to the system 100, may be realized as part of the audio system of the vehicle, or may be realized as part of another system or subsystem of the vehicle. Briefly, the audio transducer 104 may receive audio signals from the navigation processor 108, and generate corresponding audible representations of navigation instructions, user prompts, warning signals, and other sounds as necessary to support the function of the system 100. Accordingly, the audio transducer 104 represents another suitable embodiment of a presentation element or device for the navigation system 100, which can be used to provide audible navigation instructions to the operator.

The user interface 106 is configured to allow the vehicle operator to enter data and/or control the functions and features of the system 100. For example, the operator can manipulate the user interface 106 to enter a starting location and a destination location for the vehicle, where the starting and destination locations are utilized by the system 100 for purposes of route planning. If the desired starting location corresponds to the current vehicle location, then the operator need not enter the starting location if the system 100 includes a source of current vehicle position information. The user interface 106 may be realized using any conventional device or structure, including, without limitation: a keyboard or keypad; a touch screen (which may be incorporated into the display element 102); a voice recognition system; a cursor control device; a joystick or knob; or the like.

The instruction scheme selection module 110 may be realized as a distinct element of the navigation system 100 that is coupled to the navigation processor 108. Alternatively, the selection module 110 could be fully or partially incorporated into the navigation processor 108. The selection module 110 includes or executes certain functions and operations related to the selection of a designated navigation instruction scheme from a plurality of different available navigation instruction schemes that could be used to provide navigation instructions to the operator. The system 100 supports a plurality of navigation instruction schemes, and the selection module 110 selects one of the schemes in the manner described in more detail herein. In certain embodiments, the selection module selects the designated navigation instruction scheme in response to a user request command obtained via the user interface 106. In some embodiments, the selection module 110 automatically selects the designated navigation instruction scheme by presenting a series of questions to the operator (during, e.g., an initialization routine, a learning procedure, or the like), where the answers to the questions influence which scheme is selected by the selection module 110.

Each of the different navigation instruction schemes causes the navigation system 100 to present navigation instructions using distinctive, distinguishable, and noticeable content, context, formatting, style, or the like. Unlike conventional systems that merely offer different languages, different voices (female, male, celebrity, foreign accents) to convey the same content, the navigation system 100 uses instruction schemes that alter the actual content that is conveyed in the navigation instructions. For example, one navigation instruction scheme might specify cardinal directions in its navigation instructions (“turn SOUTH on Maynard Avenue; turn EAST on Fallbrook Street”), while another navigation instruction scheme might specify landmarks in its navigation instructions (“turn left at the FOUR-WAY STOP; proceed past the HOSPITAL”). A different navigation instruction scheme might specify merchant names in its navigation instructions (“turn right at ACME, INC.; turn right at ABC SKATEBOARD SHOP”), another navigation instruction scheme might specify geographic landmarks in its navigation instructions (“go straight past OWEN LAKE; turn left into OAKWOOD CANYON”), and yet another navigation instruction scheme might identify structures (such as buildings, signs, power lines, light poles, or the like) in its navigation instructions (“turn left at the BARN; drive past four TELEPHONE POLES; turn right at the WINDMILL”). These, and possibly other schemes, can be used in conjunction with (or in lieu of) conventional schemes that may rely only on street names.

A selectable navigation instruction scheme may also convey a distinctive and distinguishable tone, attitude, or personality. In this regard, one navigation instruction scheme might utilize verbose navigation instructions (“please drive ahead about one mile, then turn right at Country Road”), while a different navigation instruction scheme might utilize succinct navigation instructions for the same driving maneuver (“right at Country Road”). As another example, one navigation instruction scheme could utilize assertive navigation instructions (“TURN RIGHT AT COUNTRY ROAD”), while a different navigation instruction scheme might utilize unassertive navigation instructions for the same driving maneuver (“you are approaching Country Road; prepare to turn right”). As yet another example, a given navigation instruction scheme might utilize authoritative, non-authoritative, aggressive, or passive navigation instructions, where the instructions are vocalized using authoritative, non-authoritative, aggressive, or passive tone, pitch, intonation, emphasis, or the like. As another example, one navigation instruction scheme might utilize formal navigation instructions (“please drive ahead two miles, then make a left turn at Washington Street”), while a different navigation instruction scheme could utilize informal navigation instructions for the same driving maneuver (“left at Washington”). Moreover, a navigation instruction scheme might utilize serious navigation instructions (“proceed to Main Street, then turn right”), while another navigation instruction scheme might utilize humorous navigation instructions (“turn on Main or go back to driving school, dummy!”). Moreover, a navigation instruction scheme might present the street name of one or more approaching streets to provide early warning of the next maneuver (“keep right to prepare to turn after passing First Street”), while another navigation instruction scheme might give directions with relationships or references to major roads, highways, or other roadways (“turn right onto Jefferson after crossing Constitution Avenue, turn left onto Frontage Road after passing under I-75”), and yet another navigation instruction scheme might provide a variable or adjustable amount of advance warning or preparation for upcoming navigation maneuvers (e.g., “turn right in 0.5 mile” or “turn right in 500 feet” or “turn right NOW”). As another example, a navigation instruction scheme could allow users to program their names (or other identifier) for purposes of personalized voice prompts from the system and/or navigation instructions that contain the programmed names (e.g., “Borat, turn right at the next intersection”).

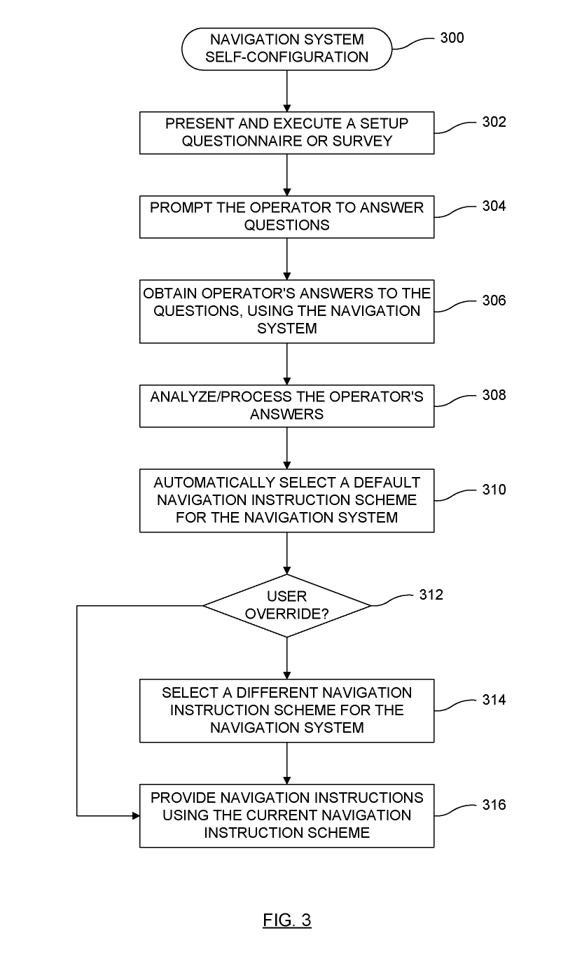

In certain embodiments, the selection module 110 (and/or other processing logic in the navigation system 100) performs an initialization, setup, or automated self-configuration routine that enables the navigation system 100 to intelligently select a designated navigation instruction scheme in a manner that best suits the needs, habits, and/or preferences of the operator. For example, the selection module 110 could be programmed to execute a setup questionnaire that includes a series of questions designed to obtain useful information from the operator. This function of the navigation system 100 is described in more detail below with reference to FIG. 3.

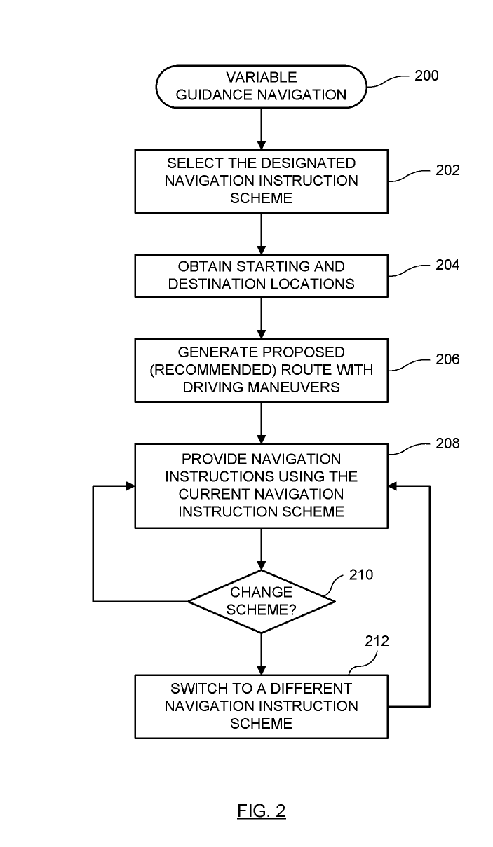

The navigation system 100 can perform a number of navigation functions, operations, processes, and methods, which are described in more detail herein. Typically, the system 100 generates and presents guidance information and instructions associated with a proposed or default route to a destination. In addition, the system 100 is able to vary and change the navigation instruction scheme to best suit the needs, preferences, and habits of the operator of the vehicle. Certain features of the navigation system 100 are described below with reference to processes depicted in FIG. 2 and FIG. 3. The various tasks performed in connection with a described process may be performed by software, hardware, firmware, or any combination thereof. For illustrative purposes, the following description may refer to elements mentioned above in connection with FIG. 1. In practice, portions of a described process may be performed by different elements of the described system, e.g., the navigation processor, the memory element, the display element, the selection module, or the like. It should be appreciated that a given process may include any number of additional or alternative tasks, the tasks shown in the figures need not be performed in the illustrated order, and a described process may be incorporated into a more comprehensive procedure or process having additional functionality not described in detail herein. Moreover, in some embodiments, one or more of the illustrated tasks may be omitted.

FIG. 2 is a flow chart that illustrates an embodiment of a variable guidance navigation process 200. The process 200 may be performed by, for example, the navigation system 100. The process 200 may begin by selecting a designated, default, or initial navigation instruction scheme from a plurality of supported and available schemes (task 202). As explained above, each of the different schemes causes the navigation system to present a given navigation instruction using distinctive content, context, and/or formatting. In certain embodiments, task 202 is associated with the detection of a user request for the designated navigation instruction scheme, and the navigation system selects the appropriate scheme in response to the detection of the user request. For example, the navigation system might detect user interaction with the user interface, where such user interaction represents a command to select one of the available navigation instruction schemes.

The process 200 may continue by obtaining a starting location and a destination location for the vehicle (task 204). The starting and destination locations may be utilized to determine one or more potential routes or potential route sections to be recommended for travel to the destination location. Next, the process 200 generates a proposed route to the destination location (task 206). The proposed route generated during the task 206 can be defined by one or more nodes or driver decision points, along with their associated driving maneuvers. This proposed route can be saved for use as the default route. In some embodiments, the process 200 may generate more than one proposed route for selection by the vehicle operator.

While the vehicle is traveling, the process 200 provides appropriate navigation instructions for the proposed route (task 208), using the designated navigation instruction scheme. The process 200 will provide navigation instructions to the vehicle operator in an ongoing manner, as is understood by those familiar with vehicle navigation systems. The navigation instructions may be realized as graphical reminders, audible warnings or instructions, or the like. In practice, navigation instructions will be presented using the initially designated navigation instruction scheme for at least one segment of the proposed route. The navigation system continues to generate navigation instructions using the designated scheme until it detects a command, situation, condition, or other triggering event that causes the process 200 to change the scheme (query task 210). If a change is needed, then the process 200 switches from the designated navigation instruction scheme to a different navigation instruction scheme, which is selected from the plurality of different schemes that are available to the navigation system (task 212). Thereafter, the process 200 proceeds to provide navigation instructions using the newly selected navigation instruction scheme (task 208). Selection of the new scheme results in the presentation of navigation instructions in accordance with the new navigation instruction scheme for at least one following segment of the proposed route.

In practice, the query task 210 may be associated with any number of triggering events. For example, the navigation system might detect user interaction with the user interface, where such user interaction represents a command to change the current navigation instruction scheme. Alternatively (or additionally), the initial navigation instruction scheme may be automatically changed in response to monitored driving trends and/or in response to monitored user interaction with the navigation system. For example, if the user frequently or habitually mutes the voice prompts, then the system might change to a less “chatty” navigation instruction scheme. Thus, the system can intelligently switch navigation instruction schemes as needed to suit the particular needs, habits, usage patterns of the user.

As mentioned previously, certain embodiments of the navigation system 100 may be suitably configured to execute a setup, initialization, training, or self-configuration procedure that customizes the navigation system 100 according to the operator's preferences, habits, personality, and/or tendencies. In this regard, FIG. 3 is a flow chart that illustrates an embodiment of a navigation system self-configuration process 300, which may be performed by the navigation system 100.

The process 300 might begin by presenting and executing a setup questionnaire or survey (task 302) with the navigation system. The questionnaire typically includes a plurality of questions for the operator, presented in an appropriate sequence or series. In certain embodiments, each question is in a multiple choice, true/false, or yes/no format, which enables the navigation system to easily obtain answers from the operator (by presenting the answer options on the display element, for example). The process prompts the operator to answer the questions contained in the questionnaire (task 304), typically via user interaction with the user interface of the navigation system.

In practice, the questionnaire is designed to solicit feedback from the operator, where such feedback is indicative of the operator's preferences, driving habits, personality, likes or dislikes, attitude, disposition, or the like. In turn, this feedback can be analyzed by the navigation system to determine how best to present navigation instructions to the operator. In this regard, an exemplary questionnaire might include at least one question related to personality traits of the operator, at least one question related to the driving habits of the operator, at least one question related to the manner in which the operator prefers to give navigation instructions to others, or the like. For example, the process 300 might ask questions such as the following, without limitation: Do you like to be told what to do in an assertive manner? When you give driving directions, do you always provide street names? Do you like to be reminded to do something more than once? Do you respond better to aggressive instructions or passive instructions? When driving, are you usually aware of the direction (North, South, East, West) in which you are headed?

As another example, the process 300 might provide different samples of navigation instructions (from the different schemes) to the user and ask the user to pick which sample(s) are preferred. The different navigation instruction options could be based on the various navigation instruction schemes available to the system, and any number of multiple-choice questions could be presented to the user. In this regard, a question might present the following options for selection by the user: (a) Turn Right on Main; (b) Turn Right at the Hospital; (c) Turn East on Main; (d) Please Take a Right in 500 Feet.

Eventually, the process 300 will obtain and collect the operator's answers to the series of questions (task 306). In certain embodiments, the navigation system itself is utilized to obtain the answers (e.g., by user interaction, voice recognition, or the like). At least some of the answers can then be analyzed and processed by the navigation system (task 308) such that it can automatically select a default or initial navigation instruction scheme for use when presenting navigation instructions (task 310). In practice, the selection performed during task 310 will be influenced by the operator's answers. Accordingly, the initial navigation instruction scheme will be automatically selected in response to the answers obtained during task 306.

An embodiment of the navigation system may allow the user to override the default navigation instruction scheme. Accordingly, if the process 300 detects a user override command (query task 312), then a different navigation instruction scheme can be selected (task 314). Otherwise, the automatically selected scheme will remain active. Thereafter, the navigation system will provide navigation instructions using the currently selected navigation instruction scheme (task 316).

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A navigation method for instructing an operator of a vehicle with a navigation system, the method comprising:
selecting a designated navigation instruction scheme from a plurality of different navigation instruction schemes, wherein each of the different navigation schemes causes the navigation system to present a given navigation instruction using distinctive content, context, or formatting;
obtaining a destination location;
generating a proposed route to the destination location; and
providing first navigation instructions for the proposed route, using the designated navigation instruction scheme.

2. The method of claim 1, further comprising:
switching from the designated navigation instruction scheme to a different navigation instruction scheme selected from the plurality of different navigation instruction schemes; and
providing second navigation instructions for the proposed route, using the different navigation instruction scheme.

3. The method of claim 1, further comprising:
executing a setup questionnaire with the navigation system, the setup questionnaire prompting the operator to respond to a series of questions; and
obtaining the operator's answers to the series of questions, wherein the selecting step is influenced by the operator's answers.

4. The method of claim 3, wherein the selecting step is automatically performed in response to the obtaining step.

5. The method of claim 1, further comprising:
executing a setup questionnaire with the navigation system, the setup questionnaire providing samples of navigation instructions from the plurality of different navigation instruction schemes; and
obtaining operator-selected ones of the samples of navigation instructions, wherein the selecting step is influenced by the operator-selected ones of the samples of navigation instructions.

6. The method of claim 1, wherein the plurality of different navigation instruction schemes comprises:
a first navigation instruction scheme that specifies cardinal directions in its navigation instructions;
a second navigation instruction scheme that specifies landmarks in its navigation instructions; and
a third navigation instruction scheme that specifies merchant names in its navigation instructions.

7. The method of claim 1, wherein the plurality of different navigation instruction schemes comprises:
a first navigation instruction scheme that utilizes verbose navigation instructions; and
a second navigation instruction scheme that utilizes succinct navigation instructions.

8. The method of claim 1, wherein the plurality of different navigation instruction schemes comprises:
a first navigation instruction scheme that utilizes assertive navigation instructions; and
a second navigation instruction scheme that utilizes unassertive navigation instructions.

9. The method of claim 1, wherein the plurality of different navigation instruction schemes comprises:
a first navigation instruction scheme that utilizes authoritative navigation instructions; and
a second navigation instruction scheme that utilizes non-authoritative navigation instructions.

10. The method of claim 1, wherein the plurality of different navigation instruction schemes comprises:
a first navigation instruction scheme that utilizes formal navigation instructions; and
a second navigation instruction scheme that utilizes informal navigation instructions.

11. The method of claim 1, wherein the plurality of different navigation instruction schemes comprises:
a first navigation instruction scheme that provides a high amount of advance warning for upcoming navigation maneuvers; and
a second navigation instruction scheme that provides a low amount of advance warning for upcoming navigation maneuvers, relative to the high amount.

12. A navigation system for instructing an operator of a vehicle, the navigation system comprising:
a navigation processor configured to obtain a destination location, and to generate a proposed route to the destination location;
a presentation element coupled to the navigation processor, the presentation element configured to provide navigation instructions to the operator; and
a selection module coupled to or incorporated into the navigation processor, and configured to select a designated navigation instruction scheme from a plurality of different navigation instruction schemes; wherein:
for a given navigation instruction, the plurality of different navigation instruction schemes provide different instruction content; and
the presentation element provides navigation instructions for the proposed route, using the designated navigation instruction scheme.

13. The navigation system of claim 12, wherein:
the presentation element comprises an audio transducer; and
the audio transducer is configured to generate audible representations of the navigation instructions in accordance with the designated navigation instruction scheme.

14. The navigation system of claim 12, wherein the designated navigation instruction scheme is selected from the group consisting of:
a first navigation instruction scheme that specifies cardinal directions in its navigation instructions;
a second navigation instruction scheme that specifies geographic landmarks in its navigation instructions; and
a third navigation instruction scheme that identifies structures in its navigation instructions.

15. The navigation system of claim 12, wherein the designated navigation instruction scheme is selected from the group consisting of:
a first navigation instruction scheme that utilizes verbose navigation instructions;
a second navigation instruction scheme that utilizes succinct navigation instructions;
a third navigation instruction scheme that utilizes aggressive navigation instructions;
a fourth navigation instruction scheme that utilizes passive navigation instructions;
an fifth navigation instruction scheme that utilizes authoritative navigation instructions;
a sixth navigation instruction scheme that utilizes non-authoritative navigation instructions;
a seventh navigation instruction scheme that utilizes serious navigation instructions;
an eighth navigation instruction scheme that utilizes humorous navigation instructions;
a ninth navigation instruction scheme that presents street names of one or more approaching streets prior to an upcoming navigation maneuver;
a tenth navigation instruction scheme that utilizes navigation instructions with references to major roadways;
an eleventh navigation instruction scheme that utilizes a variable amount of advance warning for upcoming navigation maneuvers; and
a twelfth navigation instruction scheme that utilizes navigation instructions containing a user-programmed identifier.

16. A navigation method for instructing an operator of a vehicle with a navigation system, the method comprising:
using the navigation system to present a questionnaire to the operator, the questionnaire prompting the operator to respond to a number of questions;
obtaining, with the navigation system, the operator's answers to the questions;
automatically selecting, in response to the operator's answers, a default navigation instruction scheme from a plurality of different navigation instruction schemes, resulting in an automatically selected navigation instruction scheme; and
providing navigation instructions in accordance with the automatically selected navigation instruction scheme.

17. The method of claim 16, wherein the number of questions includes at least one question related to personality traits of the operator.

18. The method of claim 16, wherein the number of questions includes at least one question related to driving habits of the operator.

19. The method of claim 16, wherein the number of questions includes at least one question related to the manner in which the operator prefers to give navigation instructions to others.

20. The method of claim 16, wherein each of the different navigation schemes causes the navigation system to present a given navigation instruction using distinctive content, context, or formatting.
